(19) United States
(12) Patent Application Publication
(10) Pub. No.: US 2020/0370597 A1
(43) Pub. Date: Nov. 26, 2020

(54) ELECTRICALLY CONDUCTIVE AND SELF-LUBRICATING BEARING LINER, BEARING CONTAINING THE SAME, AND METHOD OF MANUFACTURING SUCH A BEARING LINER

(71) Applicant: AKTIEBOLAGET SKF, GOTEBORG (SE)

(72) Inventors: Andrew Bell, Newton Abbot (GB); Michael Brett Colton, Bristol (GB)

(21) Appl. No.: 16/871,924

(22) Filed: May 11, 2020

(30) Foreign Application Priority Data
May 20, 2019 (EP) 19175443.1

(51) Int. Cl. F16C 33/10; F16C 17/02

(52) U.S. Cl. CPC F16C 33/1095; F16C 17/02

(57) ABSTRACT

A bearing liner includes a first fabric having a fiber sheet pre-impregnated with a binder. A second fabric is impregnated with the binder and has a bearing element contact surface with lubricating fibers and structural fibers supporting the bearing element contact surface. The fiber sheet and the binder incorporate electrically conductive fillers.

### CROSS-REFERENCE

This application claims priority to European Patent Application No. 19175443.1 filed on May 20, 2019, the entire contents of which are fully incorporated herein by reference.

### BACKGROUND OF THE INVENTION

The present invention relates to bearings, and more particularly to liners for plain bearings.

Bearings are well known and function to permit constrained relative motion between two parts. A plain bearing is the simplest type of bearing, comprising just a bearing surface and no rolling elements. The journal, i.e. the part of the shaft in contact with the bearing, slides over the bearing surface. The simplest example of a plain bearing is a shaft rotating in a hole.

Two-piece plain bearings, known as “full” bearings in industrial machinery, are commonly used for larger diameter applications, such as crankshaft bearings. Self-lubricating plain bearings have a lubricant contained within the bearing walls. The lubricant is typically an integral element of the bearing material and remains part of the bearing for its useful life without the need of outside maintenance.

Plain bearings often contain a liner between the bearing surfaces to reduce friction. Examples of bearing liners and their manufacturing processes are described in EP-A1-2 955 400. Fabric liners are laminated with a fiber sheet pre-impregnated with a resin binder. The resulting laminate is then compressed at an elevated temperature so that the binder bleeds through to impregnate the fabric.

### SUMMARY OF THE INVENTION

The present invention provides a bearing liner comprising a first fabric having a fiber sheet pre-impregnated with a binder. The bearing liner further comprises a second fabric impregnated with the binder and having a bearing element contact surface with lubricating fibers, as well as structural fibers supporting the bearing element contact surface.

In the present invention, the fiber sheet and the binder incorporate conductive fillers. As such, the bearing liner is electrically conductive. Conductive fillers of the fiber sheet are impregnated with a binder that also include conductive fillers. Thereby, electric current can pass through the liner.

In certain applications, for example aircraft landing gears, the use of the present bearing liner eliminates the need to provide any additional electrically conductive paths. The present liner permits a reduction in the number of parts required in certain applications, and thereby a corresponding cost savings and a reduction in manufacturing steps. The present bearing liner can be used in many applications requiring electrically conductive parts. Further, the electrically conductive bearing liner is also self-lubricating to increase the product life of a bearing incorporating the present liner.

According to further aspects of the invention which are advantageous but not required, such a bearing liner may incorporate one or more of the following features:
conductive fillers comprise graphite fillers and/or carbon fillers and/or metallic fillers, such as copper or silver;
the binder comprises at least 2 wt. % of graphite fillers;
the binder comprises a resin, preferably a phenolic resin;
the lubricating fibers comprise PTFE; and
the structural fibers comprise from 10 to 30 wt. % glass and/or carbon and/or polyester and/or aramid, and from 70 to 90 wt. % PTFE.

In a further aspect, the invention also provides a bearing comprising an inner ring, an outer ring, and a bearing liner as disclosed herein disposed between the inner and outer rings.

According to further aspects of the invention which are advantageous but not required, such a bearing may incorporate one or several of the following features:
the bearing liner is fixed to an inner surface of the outer ring, the bearing element surface being in contact with an outer surface of the inner ring;
the bearing liner is fixed to an outer surface of the inner ring, the bearing element surface being in contact with an inner surface of the outer ring;
the inner ring has a convex outer surface, and the outer ring has a concave inner surface;
the outer ring has a convex inner surface, and the inner ring has a concave outer surface;
at least one of the rings is formed of a bearing steel, for example AMS 5630 or AMS 5643;
the inner ring is a rotating journal;
the outer ring is a fixed housing; and
the bearing is a plain bearing.

In a further aspect, the invention provides a method of manufacturing a bearing liner as discussed above, the method comprising the steps of:
providing a first fabric comprising a fiber sheet pre-impregnated with a binder, the fiber sheet and the binder incorporating conductive fillers;
providing a second fabric comprising a bearing element contact surface with lubricating fibers and structural fibers supporting the bearing element contact surface; and
contacting and compressing together the first and second fabrics at an elevated temperature such that at least some of the binder in the first fabric transfers to the second fabric and impregnates the second fabric with the conductive fillers.

In the contacting and compressing step, the binder-impregnated and electrically conductive first fabric is advantageously pressed against the side of second fabric with structural fibers, i.e. the side opposite the bearing element surface.

The present method permits the combination of the two fabrics to form an integral bearing liner. The electrically conductive binder of the first fabric impregnates the second fabric with self-lubricating and structural fibers. The second fabric is then electrically conductive.

The compressing step of the process is preferably conducted at an elevated temperature, for example 160-180° C. The temperature used will depend on the nature of binder material. The elevated temperature facilitates the amount of binder that is transferred to, and impregnates, the second fabric. The first and/or the second fabric(s) is/are typically woven.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a half-axial section of a bearing comprising a bearing liner according to the invention; and

FIG. 2 is a schematic bearing liner according to the invention.

### DETAILED DESCRIPTION OF THE INVENTION

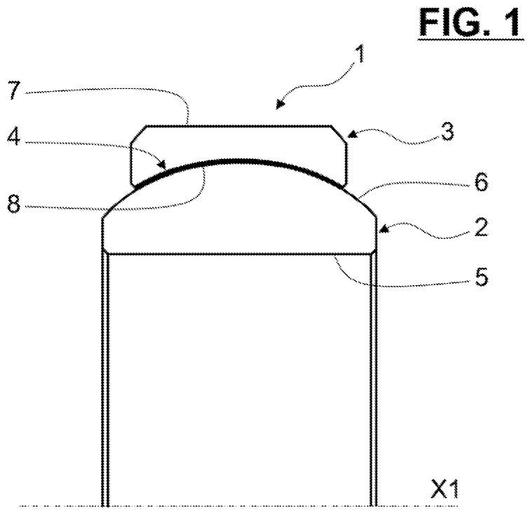

Referring to FIG. 1, a bearing 1 is centered about a main axis X1 and comprises an inner ring 2, an outer ring 3 and a bearing liner 4 disposed therebetween. The inner ring 2 has a cylindrical bore 5 and a convex outer surface 6 of at least generally spherical shape. The inner ring 2 is preferably formed of a bearing steel, for example AMS5630.

The outer ring 3 is concentrically positioned with respect to the inner ring 2. The outer ring 3 includes a cylindrical outer surface 7 and a concave inner surface 8 of at least generally spherical shape. The inner surface 8 of the outer ring 3 and the outer surface 6 of the inner ring 2 are formed of corresponding or complementary shapes to permit relative motion between the inner and outer surfaces 6, 8, respectively.

The inner ring 2 may be a movable ring and the outer ring 3 may be a stationary ring. Alternatively, the inner ring 2 may be a stationary ring and the outer ring 3 may be a movable ring. As a further alternative, the inner ring 2 may consist of a journal and/or the outer ring 3 may consist of a stationary housing.

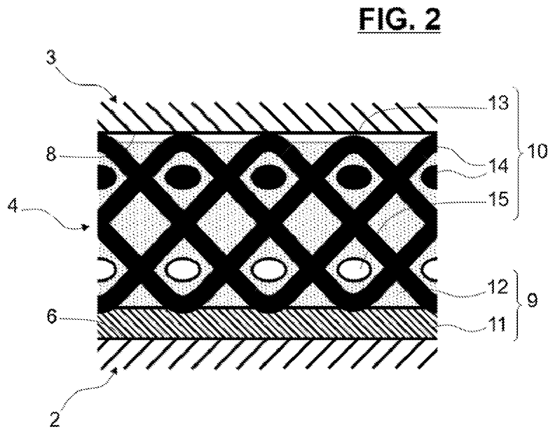

The bearing liner 4 is radially interposed or disposed between the inner surface 8 of the outer ring 3 and the outer surface 6 of the inner ring 2. The bearing liner 4 is further detailed and depicted in FIG. 2.

Basically, the bearing liner 4 comprises a first fabric 9 and a second fabric 10. The first fabric 9 includes a fiber sheet 11 pre-impregnated with a binder 12. Preferably, the binder 12 includes a resin, and most preferably a phenolic resin.

The second fabric 10 has a bearing element contact surface 13 with lubricating fibers 14, and structural fibers 15 supporting the bearing element contact surface 13. Preferably, the lubricating fibers include polytetrafluoroethylene (“PTFE”). The structural fibers preferably include between about ten percent by weight (10 wt. %) and thirty percent by weight (30 wt. %) of glass, carbon, polyester and/or aramid (i.e., 10-30 wt. % of any one or more (or all) of these materials) and between about seventy percent by weight (70 wt. %) and ninety percent by weight (90 wt. %) of PTFE. Further, the second fabric 10 is impregnated with the same binder 12 as the first fabric 9.

In the embodiment depicted in FIG. 2, the bearing liner 4 is fixed to the outer surface 6 of the inner ring 2, the bearing element contact surface 13 being in sliding contact with the inner surface 8 of the outer ring 3. Alternatively, the bearing liner 4 may be fixed to the inner surface 8 of the outer ring 3, the bearing element contact surface 13 being in sliding contact with the outer surface 6 of the inner ring 2. In any case, such a self-lubricated bearing liner 4 permits a reduced wear rate during the service life of the bearing 1.

Further, the fiber sheet 11 and the binder 12 incorporate or include electrically conductive fillers. Due to the conductive fillers, the first fabric 9 is electrically conductive. As the resin binder 12 of the first fabric 9 also impregnates the second fabric 10, the second fabric 10 is also electrically conductive.

Preferably, the conductive fillers comprise graphite fillers and/or metallic fillers, such as copper or silver. Most preferably, the binder 12 comprises or includes at least two percent by weight (2 wt. %) of graphite fillers to ensure efficient electrical conductivity.

With such conductive fillers, the bearing liner 4 permits electric current to pass through the liner 4. The bearing 1 is then electrically conductive between the inner and outer rings 2, 3 through the outer and inner surfaces 6, 8, respectively, and the bearing liner 4.

Further, a method of manufacturing such a self-lubricated and electrically conductive bearing liner 4 includes providing the first fabric 9 including a fiber sheet 11 pre-impregnated with the binder 12, with the fiber sheet 11 and the binder 12 incorporating conductive fillers.

Next, a second fabric 10 is provided which includes a bearing element contact surface 13 with lubricating fibers 14 and structural fibers 15 supporting the bearing element contact surface 13. Finally, the first and second fabrics 9, 10 are contacted and compressed together at an elevated temperature, such that at least a portion of the binder 12 in the first fabric 9 transfers to the second fabric 10 and impregnates the second fabric 10.

In the contacting and compressing stage, the binder-impregnated and electrically conductive first fabric 9 is preferably pressed against the side of second fabric 10 with structural fibers 15, i.e. the side opposite the bearing element surface 13. As stated above, the compressing operation is preferably carried out or conducted at an elevated temperature, for example in the range of 160° Celsius-180° Celsius, to facilitate the transfer and impregnation of the binder 12 to the second fabric 10.

The bearing 1 illustrated in FIG. 1 is a plain bearing, which is preferably suitable for aerospace applications. As aerospace bearings generally operate under particularly arduous conditions (i.e., extreme temperatures, high pressures, etc.), such bearings often fail sooner than desired. As a result, aircraft maintenance guidelines require frequent inspections of the bearings used in these applications. Due to relatively low wear rate of the present bearing liner 4, the average time between replacement of the bearing 1 when used in an aerospace application may be increased.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved seal assemblies.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

We claim:

1. A bearing liner comprising:
a first fabric having a fiber sheet pre-impregnated with a binder; and
a second fabric impregnated with the binder and having a bearing element contact surface with lubricating fibers and structural fibers supporting the bearing element contact surface;
wherein the fiber sheet and the binder include electrically conductive fillers.

2. The bearing liner according to claim 1, wherein the conductive fillers include at least one of graphite fillers, metallic fillers and carbon fillers.

3. The bearing liner according to claim 2, wherein the binder includes at least two percent by weight (2 wt. %) of graphite fillers.

4. The bearing liner according to claim 1, wherein the binder includes a resin.

5. The bearing liner according to claim 1, wherein the lubricating fibers include polytetrafluorethylene (PTFE).

6. The bearing liner according to claim 1, wherein the structural fibers include:
between ten percent by weight (10 wt. %) and thirty percent by weight (30 wt. %) of at least one of glass, carbon, polyester and aramid; and
between seventy percent by weight (70 wt. %) and ninety percent by weight (90 wt. %) of polytetrafluorethylene (PTFE).

7. A bearing comprising:
an inner ring;
an outer ring; and
a bearing liner disposed between the inner and outer rings and including:
a first fabric having a fiber sheet pre-impregnated with a binder; and
a second fabric impregnated with the binder and having a bearing element contact surface with lubricating fibers, and structural fibers supporting the bearing element contact surface;
wherein the fiber sheet and the binder include electrically conductive fillers.

8. A method of manufacturing a bearing liner, the method comprising the steps of:
providing a first fabric including a fiber sheet pre-impregnated with a binder, the fiber sheet and binder including conductive fillers;
providing a second fabric having a bearing element contact surface with lubricating fibers and including structural fibers supporting the bearing element contact surface; and
contacting and compressing together the first fabric and the second fabric at an elevated temperature such that at least a portion of the binder in the first fabric transfers to the second fabric and impregnates the second fabric.

9. The method according to claim 8 wherein the step of compressing the first fabric and the second fabric at an elevated temperature includes compressing the first and second fabrics at a temperature within a range of between about one hundred sixty degrees Celsius (160° C.) and about one hundred ninety degrees Celsius (190° C.).
